(19) United States
(12) Patent Application Publication
(10) Pub. No.: US 2015/0192601 A1
(43) Pub. Date: Jul. 9, 2015

(54) APPARATUS, SYSTEMS, AND METHODS TO CLEAN PROBES IN CLINICAL ANALYZERS

(71) Applicant: SIEMENS HEALTHCARE DIAGNOSTICS INC., Tarrytown Avenue, NY (US)

(72) Inventor: Beri J. Cohen, Hartsdale, NY (US)

(73) Assignee: Siemens Healthcare Diagnostic Inc., Tarrytown, NY (US)

(21) Appl. No.: 14/416,975

(22) PCT Filed: Jul. 25, 2013
(86) PCT No.: PCT/US13/52063

§ 371 Date: Jan. 23, 2015

Related U.S. Application Data
(60) Provisional application No. 61/675,402, filed on Jul. 25, 2012.

(51) Int. Cl. G01N 35/10; B08B 3/04; B08B 1/00

(52) U.S. Cl. CPC G01N 35/1004; B08B 1/002; B08B 3/04

(57) ABSTRACT

A probe cleaning apparatus is disclosed. Probe cleaning apparatus has a body, a reservoir within the body that is configured to contain a cleaning liquid, a partition wall configured to separate the reservoir into an inner region and an outer region, one or more liquid flow paths between the inner region and an outer region, and a cleaning member arranged in the inner region that is configured to contact an outer surface of a probe when the probe is inserted into the inner region. Cleaning liquid flows through the inner region to remove residue removed by the cleaning member. In another aspect, a disposable probe cleaning apparatus is provided. Systems and methods for carrying out probe cleaning are provided, as are other aspects.

### RELATED APPLICATIONS

This application claims priority to U.S. Provisional Application Ser. No. 61/675,402 entitled “METHOD AND SYSTEM FOR AUTOMATIC PROBE CLEANING” filed on Jul. 25, 2012, the disclosure of which is hereby incorporated by reference in its entirety herein.

### FIELD

The present invention relates generally to apparatus, systems, and methods adapted for cleaning probes in clinical chemical analyzers that are adapted to aspirate and/or dispense biological liquids, reagents, and the like.

### BACKGROUND

Handling of biological liquid samples, reagents, and other liquids is an essential part of the implementation of automated clinical chemistry test methods. Precision probes are used to aspirate and/or dispense these materials in conventional clinical chemistry analyzers. For economy, such probes are reused. Accordingly, probes are typically automatically cleansed and rinsed and may be dried at a station (a.k.a. a drain station) within conventional clinical chemistry analyzers. This is intended to limit an extent of carry-over of a previous sample and/or reagent artifacts or carry-over of rinse water that may dilute samples and/or reagents (“dilution”). Such carry-over and/or dilution may affect an accuracy of the clinical tests being performed.

The tasks carried out by a conventional chemical analyzer drain station are: (1) to clean and rinse the probe(s) that will be used to access the sample and/or reagent so as to minimize carry-over, and thereafter (2) in some systems to dry the probe(s) to make the probe(s) ready for reuse on a next material to be dispensed in a test or test sequence.

Currently, clinical testing instruments that use fixed non-disposable probes may require further periodical maintenance that consists of hand wiping the probe with an alcohol pad or other cleaning pad material to remove any buildup of residue on the probe from previously-contacted samples and/or reagents. This is inconvenient to users, as they may have to stop the testing, and reach deep into the clinical testing instrument. Accordingly, there is a risk of leaving a piece of the cleaning cloth or material on the probe, and possibly even bending the probe. Furthermore, the system design must be made larger to make the probe accessible by the user.

Improvement in the effectiveness of such cleaning operations may improve the overall accuracy of tests performed by the clinical chemistry analyzer, and may allow the clinical testing instrument to be made smaller. Accordingly, there is a need to improve the effectiveness of the cleansing processes carried out within such clinical chemistry analyzers.

### SUMMARY

In one aspect, the present invention provides a probe cleaning apparatus. The probe cleaning apparatus includes a body, a reservoir within the body that is configured to contain a cleaning liquid, a partition wall configured to separate the reservoir into an inner region and an outer region, one or more liquid flow paths between the inner region and an outer region, and a cleaning member arranged in the inner region that is configured to contact an outer surface of a probe when the probe is inserted into the inner region.

In another aspect, embodiments of the invention provide a disposable probe cleaning apparatus. The probe cleaning apparatus includes a body, a reservoir within the body having an opening at an upper end, a cleaning liquid contained in the reservoir, a bristle member arranged in the reservoir that is configured and operable to contact a substantial portion of an outer surface of a probe when the probe is inserted into the reservoir, and a sealing member covering the opening of the reservoir.

In another aspect, embodiments of the invention provide a probe cleaning system. The probe cleaning system includes a probe operable to dispense a biological liquid or reagent, a cleaning liquid source, a body defining a reservoir that is configured to contain a cleaning liquid received from the cleaning liquid source, the body having a probe passage configured to receive the probe, a partition wall configured to separate the reservoir into an inner region and an outer region, an inlet port providing cleaning liquid to the inner region, one or more liquid flow paths allowing liquid flow between the inner region and an outer region, an outlet port adapted to remove cleaning liquid from the outer region, and a cleaning member arranged in the inner region that is configured to contact an outer surface of a probe when the probe is inserted into the inner region.

In another embodiment, the present invention provides a method of cleaning a probe. The probe cleaning method includes lowering the probe through a probe passage and into a reservoir containing cleaning liquid and into contact with a cleaning member contained in the reservoir, moving the probe within the reservoir against the cleaning member to remove residue on an outside surface of the probe into the cleaning liquid, and removing at least some of the cleaning liquid containing the residue.

Still other aspects, features, and advantages of the present invention may be readily apparent from the following detailed description illustrating a number of example embodiments and implementations, including the best mode contemplated for carrying out the present invention. The present invention may also be capable of other and different embodiments, and its several details may be modified in various respects, all without departing from the scope of the present invention. Accordingly, the drawings and descriptions are to be regarded as illustrative in nature, and not as restrictive. The drawings are not necessarily drawn to scale. The invention is to cover all modifications, equivalents, and alternatives falling within the scope of the invention.

### BRIEF DESCRIPTION OF THE DRAWINGS

The invention will be better understood by referring to the detailed description taken in conjunction with the following drawings.

FIG. 1 is a cross-sectioned side plan view diagram of a conventional probe cleaning apparatus according to the prior art.

FIG. 2A is a cross-sectioned side plan view of a probe cleaning apparatus according to embodiments.

FIG. 2B is a side plan view of a segment of a cleaning member of a probe cleaning apparatus, shown in a straightened condition for clarity, according to embodiments.

FIG. 2C is a cross-sectioned side plan view of another probe cleaning apparatus according to embodiments.

FIG. 2D is a cross-sectioned top view of the probe cleaning apparatus of FIG. 2C taken along section lines 2D-2D according to embodiments.

FIGS. 2E and 2F are side and front plan views, respectively, of brushes of a cleaning member of a probe cleaning apparatus according to embodiments.

FIG. 3 is an isometric view of a probe cleaning system including a probe cleaning apparatus and rinsing apparatus according to embodiments.

FIG. 4A is a top plan view of a disposable probe cleaning apparatus according to embodiments.

FIG. 4B is a cross-sectioned side plan view of a disposable probe cleaning apparatus taken along section line 4B-4B of FIG. 4A according to embodiments.

FIG. 5A is a top plan view of a disposable probe cleaning apparatus included in a reagent pack according to embodiments.

FIG. 5B is a cross-sectioned side plan view of a disposable probe cleaning apparatus included in a reagent pack taken along section line 5B-5B of FIG. 5A according to embodiments.

FIG. 6 is a flow chart illustrating a method of cleaning a probe according to embodiments.

### DETAILED DESCRIPTION

In view of the foregoing difficulties and the propensity for inaccurate results due to possible carry-over and/or dilution, there is an unmet need to improve the effectiveness of existing cleansing apparatus and systems. In particular, improvements in terms of effectiveness of debris removal and eliminating service access requirements to the sample probe are desired. To address this need, embodiments according to aspects of the present invention provide an improved cleansing apparatus, wherein the sample probe outer surface is cleaned through a combination of mechanical scrubbing and exposure to cleaning solution. In some embodiments, the probe cleaning apparatus includes a body having a reservoir having an opening at an upper end, a cleaning liquid contained in the reservoir, and a bristle member (e.g., a helical bristle member) arranged in the reservoir that is configured and operable to contact a substantial portion of an outer surface of a probe when inserted into the reservoir. The robot adapted to cause motion of the probe may oscillate the probe up and down within the reservoir and against the bristle member to remove any debris buildup on the outside of the probe.

Some embodiments of the probe cleaning apparatus may be configured as a disposable probe cleaning pack that is a removable and disposable component such that after a predefined number of uses (probe cleaning cycles), the probe cleaning pack may be removed from the clinical instrument and discarded. The removed probe cleaning pack may then be replaced with a new cleaning pack. In this instance, the probe cleaning pack may have a sealing member (e.g., a foil covering) covering and sealing the opening of the reservoir. The sealing member may be pierced by the probe tip, and once it is pierced, the probe may continue to access the reservoir through the pierced opening.

In another embodiment, the probe cleaning apparatus may be configured with a body having a reservoir that is configured to contain a cleaning liquid, and a partition wall configured to separate the reservoir into an inner region and an outer region. One or more liquid flow paths between the inner region and an outer region may be provided and a bristle member is arranged in the inner region that is configured to contact an outer surface of the probe when inserted into the inner region. In this manner the cleaning liquid may be replaced continuously and/or intermittently as it becomes contaminated via the mechanical cleaning of the probe. Moreover, the top of the probe cleaning apparatus may be removed so that the bristled member may be replaced.

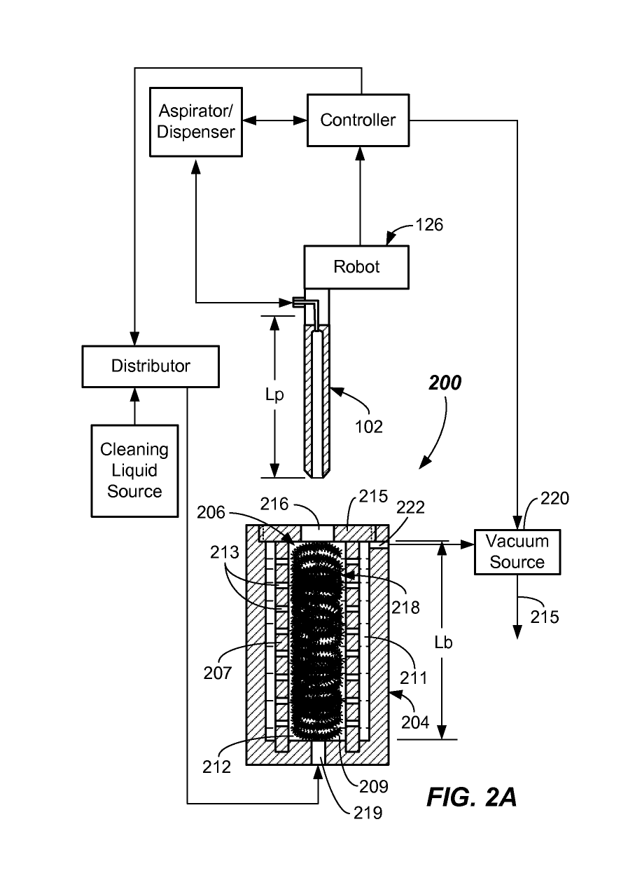

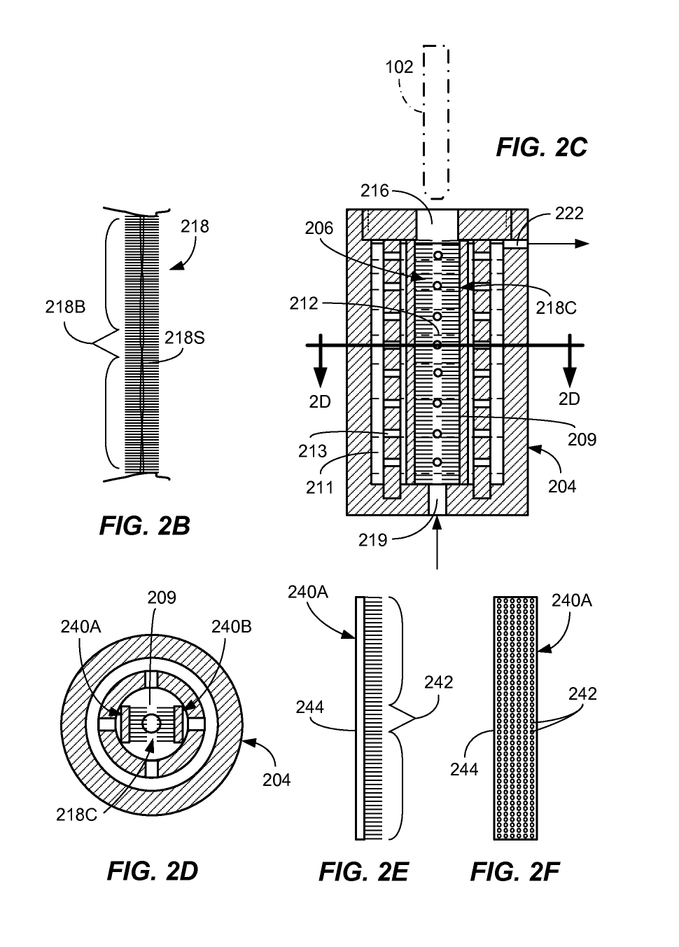

These and other aspects and features of the invention will be described with reference to FIGS. 2A-6 herein.

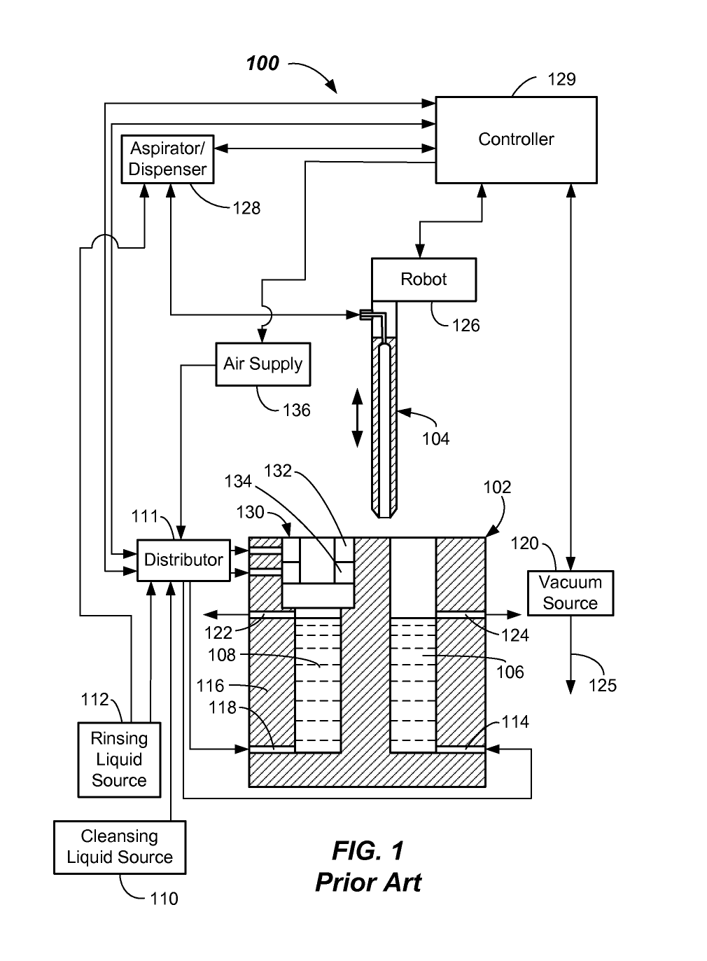

FIG. 1 illustrates a portion of a clinical analyzer 100 according to the prior art that includes a conventional rinsing and drying apparatus 102 (otherwise referred to as a “drain station”). The rinsing and drying apparatus 102 has two locations for the probe 104 to enter, namely a cleansing well 106 and a rinsing well 108. Each well 106, 108 may be bottom-fed from respective cleansing liquid source 110 and rinsing liquid source 112. Cleansing liquid is supplied to cleansing well 106 from the cleansing liquid source 110 through distributor 111 and passage 114 formed in the drain station body 116 to provide a static cleansing bath. Rinsing liquid is supplied to the rinsing well 108 from rinsing liquid source 112 through distributor 111 and passage 118 to provide a rinsing bath. A vacuum overflow feature may be provided that maintains predetermined fluid height within the wells 106, 108, and removes waste material, and liquid entering the wells 106, 108. A suitable vacuum source 120 is coupled to (coupling is not shown) exhaust ports 122, 124 interfacing with each of the wells 106, 108 at a predetermined well height and carries the exhausted liquids, other materials, and air to a drain 125.

The cleansing well 106 may typically hold either sodium hypochlorite or sodium hydroxide cleaning liquids, and the rinsing well 108 may hold water. A robot 126 causes the sample probe 104 to move in two or more coordinate directions (e.g., vertical and horizontal). Accordingly, the probe 104 may aspirate sample, reagent, or other liquid at a first location with an aspirator/dispenser unit 128 and move the sample, reagent, or other liquid contained in the probe 104 to a second location and dispense the sample, reagent, or other liquid, such as into a cuvette. Optionally, or in addition, rinsing liquid from the rinsing liquid source 112 may be dispensed by the aspirator/dispenser 128 through the sample probe 104 to rinse an interior of the sample probe 104.

At the top end of the rinsing well 108, a nozzle assembly 130 may be provided. The nozzle assembly 130 may have any suitable projecting features, such as two sets of nozzles. The projecting features may be an air-knife feature 132 and a shower feature 134. The features 132, 134 direct multiple air jets provided from an air supply 136 and water jets from rinsing liquid source 112 to wash and dry the probe 104 received in the rinsing well 108, respectively.

The rinsing and drying apparatus 102 functions with the following typical sequence. The sample probe 104 is lowered by robot 126 into the cleansing well 106 to soak the exterior surfaces thereof. Cleansing solution may be aspirated by aspirator/dispenser 128 into the probe 104 to soak the interior surfaces of the probe 104. The probe 104 is withdrawn from the cleansing well 106 by robot 126 and repositioned over the rinsing well 108. The probe 104 is lowered by robot 126 into the rinsing well 108. The probe 104 and the upper section of the rinse well 108 may be showered with water (via shower feature 134) from rinsing liquid source 112. Rinsing solution may be flushed through the interior of the probe 104 using aspirator/dispenser 128. Rinsing solution may be pumped into the bottom of the rinsing well 108 to flush and replenish the static rinsing bath. The probe 104 is withdrawn by robot 126 from the rinsing well 108 while the air-knife jets attempt to wipe away remaining water droplets from the outer surface of the probe 104 (via air-knife feature 132). Control of the various probe movements as well as the rinsing and cleaning operations are via control signals from controller 129.

However, even though the conventional rinsing and drying apparatus and systems are generally adequate, they may require periodic additional manual probe cleaning/maintenance, which may cause the user to stop the instrument for service.

Thus, there remains a need for improved cleaning apparatus that produces more effective cleaning and/or minimizes or eliminates the need for such additional manual probe cleaning operations.

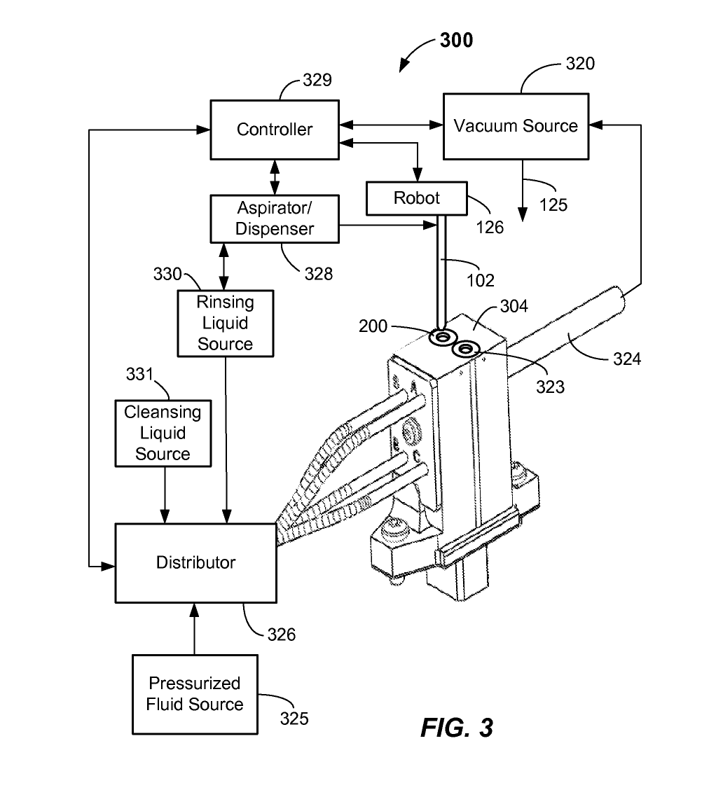

Referring now to FIG. 2A-3, an improved probe cleaning apparatus 200 is illustrated according to embodiments of the invention. The probe cleaning apparatus 200 provides improved mechanical cleaning of the probe 102 and the ability to wash away probe residue from the cleaning reservoir.

In more detail, a first embodiment of the present invention will now be described. The probe cleaning apparatus 200 includes a body 204 defining a reservoir 206 within the body 204 configured and adapted to contain a liquid 212 (e.g., a cleaning liquid). The depth of the liquid 212 may be at or near the top of the reservoir 206. The body 204 may be manufactured from any suitable polymeric material, such as an acrylic material. Other suitable materials may be used. As shown, a partition wall 207 may be configured to separate the reservoir 206 into an inner region 209 and an outer region 211. The partition wall 207 may comprise an annular cylindrical member having one or more radial liquid flow passages 213 (e.g., plurality of apertures—a few labeled) formed therein. The inner region 209 may be a cavity that is circular in cross section (see e.g., FIG. 2D). In some embodiments, a plurality of radial liquid flow passages 213 may be provided in the partition wall 207. The one or more liquid flow paths 213 may fluidly connect between the inner region 209 and an outer region 211 and allow liquid 212 to flow between the inner region 209 and outer region 211, for example. A cleaning member 218 is provided within the reservoir 206 and may be arranged within the inner region 209. Cleaning member 218 is configured and operable to contact an outer surface of the probe 102 when the probe 102 is inserted into the inner region 209 through a probe passage 216.

The probe cleaning apparatus 200 may have a removable top 215 having the probe passage 216 formed therein. Probe passage 216 may be centered on the inner region 209 of the reservoir 206 in some embodiments. The probe passage 216 is adapted to receive the probe 102 therein. The top 215 may function to restrain the cleaning member 218 and prevent the cleaning member 218 from being pulled from the reservoir 206 when the probe 102 is retracted therefrom.

Cleaning member 218 may be of any suitable construction. For example, the cleaning member 218 as shown in FIG. 2B may have bristles 218B that extend generally toward an outer surface of the probe 102. In the embodiment shown in FIG. 2A-2B, the cleaning member 218 may comprise a bent support member 218S (e.g., having twisted wires) with bristles 218B secured to the support member 218S along a bent length thereof. Twisted wires comprising the support member 218S having bristles 218B (e.g., plastic or other suitable semi-rigid material) bound and captured therein may be used, such as shown in FIG. 2B. The support member 218S and bound bristles 218B may be wound about a mandrel having a slightly larger diameter than the probe 102 and may be formed to include a helix shape as shown in FIG. 2A. Upon removing the wound support member 218S with attached bristles 218B from the mandrel, the cleaning member 218 having a helix shape may be formed.

Cleaning member 218 may be inserted into the inner region 209 and configured to contact the probe 102 when inserted in the reservoir 206. The cleaning member 218 may extend from a top to a bottom of the inner region 209 of the reservoir 206. For example, the helical windings of the cleaning member 218 may be sufficiently close and tightly wound so that an arrangement of bristles 218B are provided that extend along the length of the inner region 209 from top to bottom and provide a bristled cavity which receives the probe 102. In some embodiments, a length Lb of the cleaning member 218 may be longer than a useable length Lp of the probe 102 when fully inserted in the reservoir 206. In some embodiments, the cleaning member 218 may be entirely submerged in the liquid 212. Other types of cleaning members may be used.

For example, as shown in FIGS. 2C-2F, the cleaning member 218C may be made of two or more brushes 240A, 240B having bristles 242 bound to a backing 244 therein, in a similar manner as a tooth brush. Brushes 240A, 240B may be arranged so that the bristles 242 extend towards each other and are provided in close proximity to one another, or even interleaved to some extent, so that they may contact the probe 102 when inserted in the inner region 209. The brush 240B is substantially identical to brush 240A shown in FIG. 2E and 2F. Various contours may be cut on the bristles 242 in some embodiments to better match an outer contour of the probe 102. As shown in FIG. 2C, the cleaning member comprising bristles 242 may extend substantially from a top to a bottom of the reservoir, as shown.

As the probe 102 is lowered through the probe passage 216 into the reservoir 206, the outside surface of the probe 102 is contacted by the many bristles (e.g., bristles 218B, 242) of the cleaning member 218, 218C. The probe 102 may be plunged under the action of the robot 126 one time, and preferably more than one time for each cleaning cycle, into the inner region 109 containing the cleaning member 218 or 218C and any residue that is adhered on the outer surface of the probe 102 may be effectively removed thereby.

In the illustrated embodiments of FIG. 2A and 2C, an inlet port 219 is coupled to the lower portion of the reservoir 206 and provides an inflow of the liquid 212 into the inner region 209. Liquid 212 may flow through or about the bristled member 218 or 218C, out through the one or more radial flow passages 213 and into the outer region 211. From there, a vacuum source 220 (FIG. 2A) coupled to one or more outlet ports 222 may be operated to draw off the liquid 212 that may have been contaminated with removed residue from the probe 102 and dispense it into a drain 215.

Another embodiment of a probe cleaning system 300 is shown in FIG. 3. Probe cleaning system 300 may also include a rinsing apparatus 323 that is positioned next to the probe cleaning apparatus 200, and may contain a rinsing liquid and is adapted to rinse the probe after cleaning in the probe cleaning apparatus 200. Both the probe cleaning apparatus 200 and the rinsing apparatus 323 may be provided in a common body 304. A common exhaust line 324 may extract used liquid from each of the rinsing apparatus 323 and the adjacent probe cleaning apparatus 200.

A vacuum from a vacuum source 320 may be applied at the exhaust line 324 coupled to the respective outlet ports of the probe cleaning apparatus 200 and the rinsing apparatus 323 in order to collect and exhaust any liquid or other residue material swept from the probe 102. In more detail, the probe cleaning system 300 includes a pressurized fluid source 325, such as pressurized air. The air may be provided at a pressure of about 20 psi, for example. Other pressures may be used. Suitable conduits may connect to a distributor 326 and, thus, pressurized air may be provided to an air-knife feature of the rinsing apparatus 323 to dry the probe 102 after rinsing. The distributor 326 may be a suitable series of valves and passages adapted to selectively cause flow of the fluids and liquids to the various reservoirs of the cleaning apparatus 200 and rinsing apparatus 323. In the depicted embodiment, the system 300 includes a common drain station body 304, a conventional rinsing apparatus 323, and the cleaning apparatus 200 as discussed above.

In operation, the probe cleaning system 300 may include any suitable moving component(s) such as robot 126 for carrying out motion of the probe 102. The robot 126 may include suitable robot components (e.g., one or more robot arms, beams, or gantries) to which the probe 102 may be mounted. Suitable motion may be imparted to the probe 102 by the robot 126, such as one-axis, two-axis, or three-axis motion. The robot 126 may be actuated by commands from suitable control 129.

In one embodiment, the sample probe 102 may first be moved above and lowered into, and is at least partially immersed in, the cleaning apparatus 200 by robot 126. While immersed in the probe cleaning apparatus 200, the aspirator/dispenser 328 may draw some of the cleaning liquid 212 into the interior of the probe 102 to cleanse same. Likewise, the robot 126 may be actuated to raise and lower the probe 102 within the reservoir 206 any suitable number of times during a particular cleaning cycle, such that the cleaning member 218 (e.g., a bristle containing member) scrubs the outer surface of the probe 102 to remove reside therefrom.

Aspirator/dispenser 328 may be adapted, and operational, as commanded by controller 329 to control a level of vacuum pressure via actuation of a suitable conventional pump (not shown) to draw in a desired amount of the sample liquid, reagent, cleaning liquid, rinsing liquid, or the like into the probe 102, and also to control the dispensing operations performed by the probe 102. The aspirator/dispenser 328 may include suitable pressure sensor(s), valve(s), accumulator(s), or other pneumatic or hydraulic components (not shown) to effectuate and possibly verify the liquid aspirating/dispensing action. Any suitable assembly for drawing the fluid into the probe 102 and dispensing liquid from the probe 102 may be used. For example, aspirating and dispensing systems that may be used with the present invention are described in U.S. Pat. Nos. 7,634,378; 7,477,997; and 7,150,190.

After cleaning the probe 102 in the probe cleaning apparatus 200, the probe 102 may be withdrawn from the cleaning apparatus 200 and moved to the rinsing apparatus 323. Any cleaning liquid 212 in the probe 102 may be dispensed by aspirator/dispenser 328 into the outlet port 222. The used cleansing liquid may then be exhausted in exhaust line 324 to a drain 125, for example. After cleaning, the cleansing liquid 212 in the reservoir 206 may be replaced from a cleaning liquid source 331 through the distributor 326.

Following cleaning, the probe 102 may be moved above and lowered by the robot 126 into the rinsing apparatus 323. In some embodiments, when the tip of the probe 102 is positioned adjacent to the exhaust port of the rinsing apparatus, rinsing liquid from rinsing liquid source 330 may be dispensed by aspirator/dispenser 328 to rinse the interior of the probe 102. The vacuum source 320 may evacuate the used rinsing liquid into exhaust port through conduit 324 and deliver it to drain 125. In some embodiments, a conventional shower feature of the rinsing apparatus 323 may be employed to receive rinsing liquid from rinsing liquid source 330 and distributor 326 to rinse an exterior of the probe 102 as the probe 102 enters or is withdrawn from a probe rinsing passage of the rinsing apparatus 323. Suitable conduits may provide supplies of rinsing liquid and cleaning liquid 212 from rinsing liquid source 330 and cleaning liquid source 331, respectively, to the bottoms of the rinsing apparatus 323 and probe cleaning apparatus 200.

After the probe 102 is rinsed, the probe 102 may be withdrawn from the rinsing apparatus 323 and a flow of fluid (e.g., air) may be provided from the pressurized fluid (air) source 325 through distributor 326 to produce fluid jets (e.g., air jets) onto the exterior of the probe 102 thereby drying the exterior of the probe 102 which has been cleaned and rinsed.

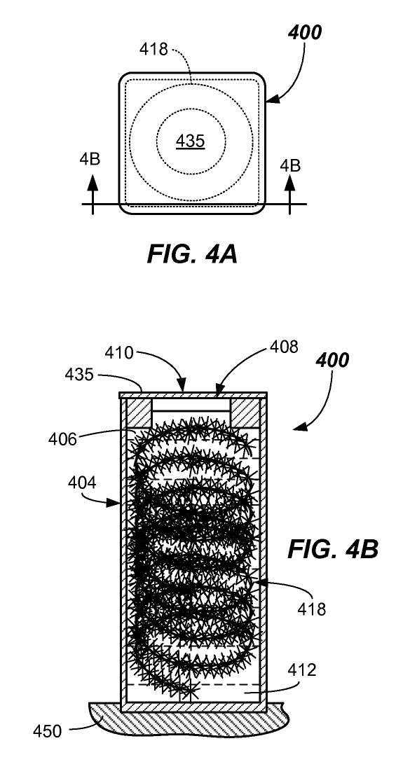

In another embodiment shown in FIGS. 4A and 4B, a probe cleaning apparatus 400 is shown. The probe cleaning apparatus 400 includes a body 404, which may have a reservoir 406 formed therein. The reservoir 406 within the body 404 has an opening 408 at an upper end 410 that is configured to receive a probe 102 therein. The probe 102 may be as previously described. A cleaning liquid 412 is contained in the reservoir 406 and a cleaning member 418 is also contained and arranged in the reservoir 406. Cleaning member 418 may be a bristle member as previously described, and is configured and operable to contact a substantial portion of an outer surface of a probe 102 when inserted into the reservoir 406. The cleaning member 418 may be a bristled member having a helical shape in some embodiments. Other types of cleaning members may be used that provide sufficient mechanical scrubbing action to remove reside from the probe 102. A sealing member 435 is provided covering the opening 408 of the reservoir 406. Sealing member 435 may be a foil or other suitable planar sealing material adhered to the upper end 410 of the body 404 or otherwise sealing the body 404. In some embodiments, the thickness and strength of the sealing member should be sufficiently low that it may be pierced (e.g., punctured) by the downward motion of the probe 102.

The depicted embodiment of probe cleaning apparatus 400 is disposable after a predefined number of uses. The probe cleaning apparatus 400 may reside in a support component 450 of a clinical testing instrument at a suitable location that is accessible by the probe 102. For example, probe cleaning apparatus 400 may be seated in a support component 450 that is a carousel of a clinical analyzer, such as at one or more locations reserved for auxiliary reagent containers, for example. Optionally, the support component 450 may be a tray of a clinical analyzer instrument.

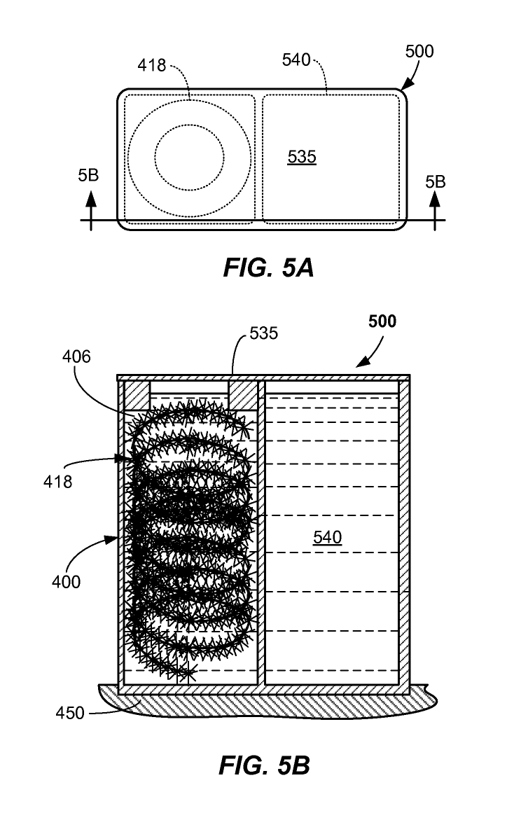

In another embodiment shown in FIGS. 5A and 5B, a probe cleaning apparatus 400 is shown included in a reagent dispenser pack 500. The probe cleaning apparatus 400 as described before, includes a cleaning member 418 (e.g., a bristled member or the like) is included in a reagent dispenser pack 500 containing one or more reagent reservoirs 540. Only one reagent reservoir 540 is shown, but two, three, or more reagent reservoirs containing one or more reagents may be provided. As in the previous embodiment, the reservoir 406 may include a sealing member 535. However, in this embodiment, the sealing member 535 seals both the reservoir 406 of the probe cleaning apparatus 400 as well as the reagent reservoir 540. The probe 102 may be operational to pierce the sealing member 535 to gain access to each of the reservoir 406 and reagent reservoir 540.

In some embodiments, the reagent dispenser pack 500 may optionally include more than one probe cleaning reservoir. For example, a reagent pack may include two probe cleaning apparatus 400 therein and two or more reagent reservoirs like reagent reservoir 540. Reagent pack 500 may be placed on a support component 450 of a clinical testing instrument at convectional locations, for example, such as on the carousel or on a reagent storage tray that may be accessible by the robot 126 and probe 102.

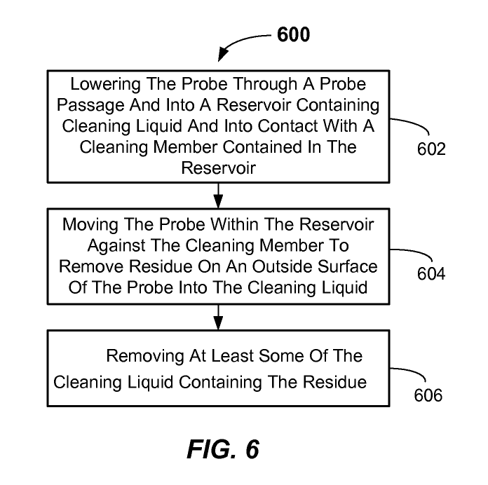

In another aspect, as best described in FIG. 6, a method 600 of cleaning a probe (e.g., probe 102) of a clinical analyzer, for example, includes, in 602, lowering the probe through a probe passage (e.g., probe passage 216) and into a reservoir (e.g., reservoir 206) containing cleaning liquid (e.g., cleaning liquid 212) and into contact with a cleaning member (e.g., cleaning member 218) contained in the reservoir.

Probe cleaning method 600 further includes, in 604, moving the probe within the reservoir against the cleaning member to remove residue on an outside surface of the probe into the cleaning liquid, and, in 606, removing at least some of the cleaning liquid containing the residue. The cleaning liquid containing the residue may be removed from the reservoir through an outlet port (e.g., outlet port 222). In some embodiments, the flow of cleaning liquid (e.g., cleaning liquid 212) is provided during or after a probe cleaning cycle. The flow of cleaning liquid may be provided by any suitable cleaning liquid supply system, and the flow may be into an inner region (e.g., inner region 209) of the reservoir, through one or more flow passages (e.g., radial flow passage 213), and then into an outer region (e.g., outer region 211) of the reservoir. Cleaning liquid containing reside may be removed from the outer region through the outlet port.

The cleaning member (e.g., cleaning member 218) may be any suitable abrasive member adapted to contact an outer surface of the probe 102, such as a bristled member, brush containing bristles, a sponge, or any other member containing a plurality of bristles or strands of material adapted to contact the probe 102 along its length Lp.

In operation, the described probe cleaning apparatus 200 and system 300 may produce a significant reduction in the residue buildup on the probe 102, thereby reducing the propensity and need for manual probe cleaning. In some embodiments, the probe cleaning operation may be embodied in a disposable pack, such as a stand-alone pack or as part of a reagent pack. This may allow the clinical analyzer to be reduced in size as the access to the probe 102 may no longer be needed for residue removal. Embodiments of the present invention may be advantageously utilized in connection with clinical analyzers, and are particularly useful for probes that aspirate liquids (sample liquids and/or reagents) that may, over time, experience reside buildup on an outer surface thereof, i.e., after multiple aspiration and dispensing cycles.

Having shown the preferred embodiment, those skilled in the art will realize many variations are possible that will still be within the scope of the claimed invention. Therefore, it is the intention to limit the invention only as indicated by the scope of the claims.

What is claimed is:

1. A probe cleaning apparatus, comprising:
a body;
a reservoir within the body that is configured to contain a cleaning liquid;
a partition wall configured to separate the reservoir into an inner region and an outer region;
one or more liquid flow paths between the inner region and an outer region; and
a cleaning member arranged in the inner region that is configured to contact an outer surface of a probe when the probe is inserted into the inner region.

2. The probe cleaning apparatus of claim 1, comprising a length Lb of the bristle member longer than a length Lp of the probe when fully inserted in the reservoir.

3. The probe cleaning apparatus of claim 1, wherein the bristle member comprises a bent support member and bristles secured to the support member along a bent length thereof.

4. The probe cleaning apparatus of claim 3, wherein the bent support member includes a helix shape.

5. The probe cleaning apparatus of claim 1, wherein the partition wall comprises a cylindrical wall and the one or more liquid flow paths comprise a plurality of apertures.

6. The probe cleaning apparatus of claim 1, comprising an inlet port adapted to supply cleaning liquid into the inner region, and an outlet port adapted to withdraw liquid from the outer region.

7. A probe cleaning apparatus, comprising:
a body;
a reservoir within the body having an opening at an upper end;
a cleaning liquid contained in the reservoir;
a cleaning member arranged in the reservoir that is configured and operable to contact a substantial portion of an outer surface of a probe when the probe is inserted into the reservoir; and
a sealing member covering the opening of the reservoir.

8. The probe cleaning apparatus of claim 7, wherein the sealing member is sealed to the opening and is configured and is adapted to be punctured by the probe.

9. The probe cleaning apparatus of claim 7, wherein the cleaning member comprises a bristle member.

10. The probe cleaning apparatus of claim 9, wherein the bristle member comprises a bent support member and bristles secured to the support member along a bent length thereof.

11. The probe cleaning apparatus of claim 7, included within a reagent dispensing pack comprising at least one reagent reservoir containing reagent.

12. The probe cleaning apparatus of claim 7, wherein the probe cleaning apparatus is disposable after a predefined number of uses.

13. The probe cleaning apparatus of claim 7, wherein the cleaning member is submerged in the cleaning liquid contained in the reservoir.

14. A probe cleaning system, comprising:
a probe operable to dispense a biological liquid or reagent;
a cleaning liquid source;
a body defining a reservoir that is configured to contain a cleaning liquid received from the cleaning liquid source, the body having a probe passage configured to receive the probe;
a partition wall configured to separate the reservoir into an inner region and an outer region;
an inlet port providing cleaning liquid to the inner region one or more liquid flow paths allowing liquid flow between the inner region and an outer region;
an outlet port adapted to remove cleaning liquid from the outer region; and
a cleaning member arranged in the inner region that is configured to contact an outer surface of a probe when the probe is inserted into the inner region.

15. The system of claim 14, wherein the cleaning member comprises bristles.

16. The system of claim 14, wherein the cleaning member comprises a bristle member having a bent support member and bristles secured to the support member along a bent length thereof.

17. The system of claim 14, wherein the cleaning member is submerged in the cleaning liquid.

18. The system of claim 14, wherein the cleaning member extends substantially from a bottom to a top of the reservoir.

19. A method of cleaning a probe, comprising:
lowering the probe through a probe passage and into a reservoir containing cleaning liquid and into contact with a cleaning member contained in the reservoir;
moving the probe within the reservoir against the cleaning member to remove residue on an outside surface of the probe into the cleaning liquid; and
removing at least some of the cleaning liquid containing the residue.

20. The method of claim 19, comprising flowing cleaning liquid between an inner region containing the cleaning member and an outer region containing an outlet port.
